(19) United States
(12) Patent Application Publication
(10) Pub. No.: US 2021/0378910 A1
(43) Pub. Date: Dec. 9, 2021

(54) Massaging Chair Assembly

(71) Applicant: Joana Saint Surin, Dorchester, MA (US)

(72) Inventor: Joana Saint Surin, Dorchester, MA (US)

(21) Appl. No.: 16/891,292

(22) Filed: Jun. 3, 2020

(51) Int. Cl. A61H 15/02; A61H 1/00; A61H 15/00; B60N 2/90; B60N 2/56

(52) U.S. Cl. CPC A61H 15/02; A61H 2201/1673; A61H 15/0078; B60N 2/976; B60N 2/5678; A61H 2205/081; A61H 2015/005; A61H 2201/0207; A61H 2201/5097; A61H 2201/1623; A61H 2201/1607; A61H 2201/1215; A61H 2201/5023; A61H 2201/0149; A61H 1/005

(57) ABSTRACT

A massaging chair assembly includes a pad that is positionable on a seat in a vehicle. A plurality of massage units is each integrated into the pad and each of the massage units abuts the user when the user sits on the pad. Each of the massage units orbits about a central point when the massage units are turned on to massage the user. A heating element is integrated into the pad and the heating element heats the pad to warm the user when the user sits on the pad. A control unit is integrated into the pad and the control unit is in electrical communication with each of the massage units and the heating element. A remote control is provided and the remote control is in wireless communication with the control unit for controlling operational parameters of the massage units and the heating element.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to massaging devices and more particularly pertains to a new massaging device for massaging a user's back while the user is driving.

### (2) Description of Related Art Including Information Disclosed Under 37 CFR 1.97 and 1.98

The prior art relates to massaging devices including a massage pad that includes metallic balls and a magnet for magnetically engaging the metallic balls. The prior art discloses a variety of massagers that include a motor and a plurality of balls being in mechanical communication with the motor, through a variety of novel mechanisms, for massaging a user. The prior art also discloses a variety of massagers that include massaging units and a heating element for heating and massaging a user. The prior art discloses a variety of massage units being integrated into a seat in a vehicle for massaging a driver of the vehicle.

### BRIEF SUMMARY OF THE INVENTION

An embodiment of the disclosure meets the needs presented above by generally comprising a pad that is positionable on a seat in a vehicle. A plurality of massage units is each integrated into the pad and each of the massage units abuts the user when the user sits on the pad. Each of the massage units orbits about a central point when the massage units are turned on to massage the user. A heating element is integrated into the pad and the heating element heats the pad to warm the user when the user sits on the pad. A control unit is integrated into the pad and the control unit is in electrical communication with each of the massage units and the heating element. A remote control is provided and the remote control is in wireless communication with the control unit for controlling operational parameters of the massage units and the heating element.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a massaging chair assembly according to an embodiment of the disclosure.

FIG. 2 is a front phantom view of an embodiment of the disclosure.

FIG. 3 is a back phantom view of an embodiment of the disclosure.

FIG. 4 is a detail view taken from circle 4 of FIG. 2 of an embodiment of the disclosure.

FIG. 5 is a cross sectional view taken along line 5-5 of FIG. 2 of an embodiment of the disclosure.

FIG. 6 is a front view of a remote control of an embodiment of the disclosure.

### DETAILED DESCRIPTION OF THE INVENTION

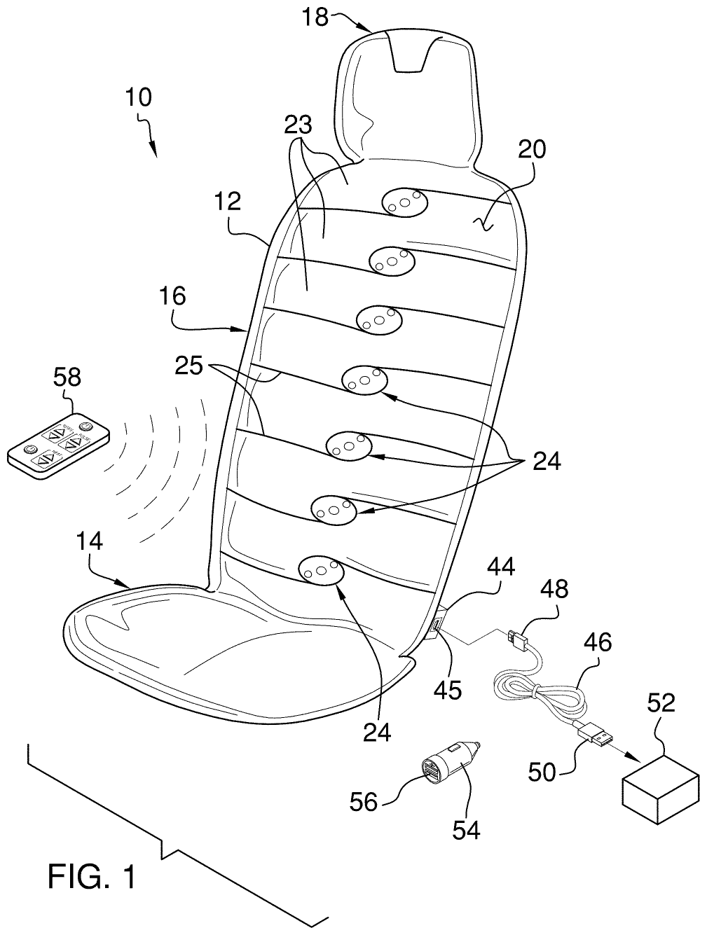

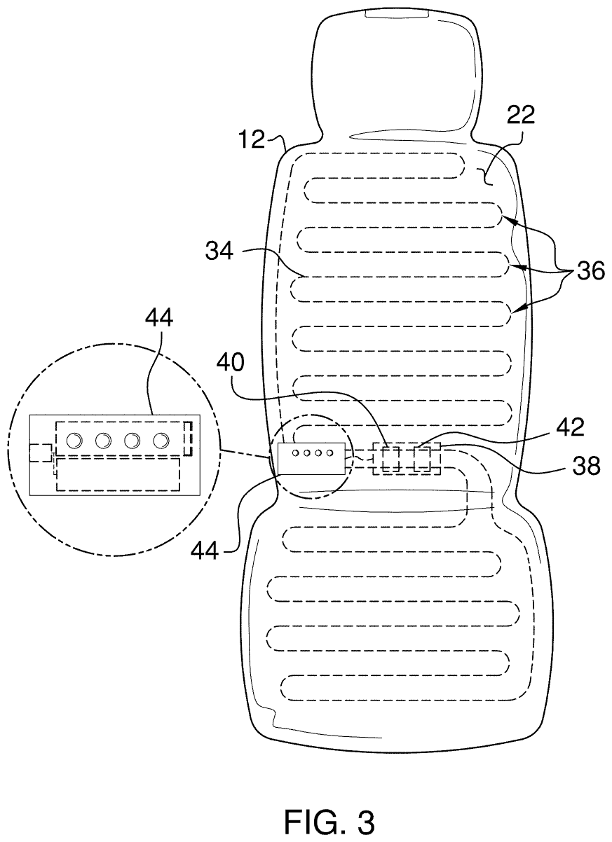

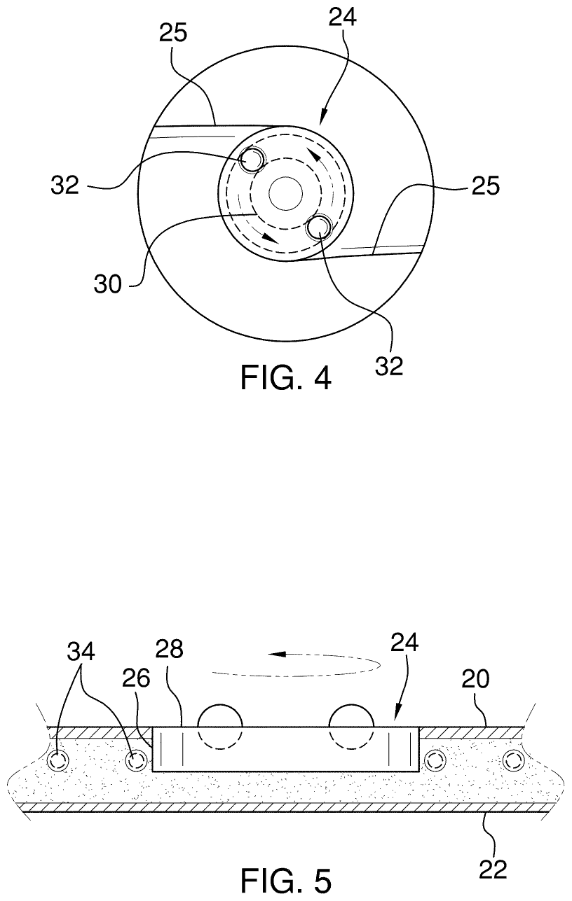

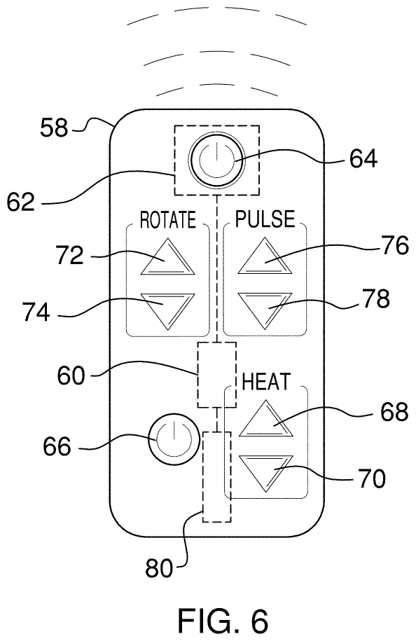

With reference now to the drawings, and in particular to FIGS. 1 through 6 thereof, a new massaging device embodying the principles and concepts of an embodiment of the disclosure and generally designated by the reference numeral 10 will be described.

As best illustrated in FIGS. 1 through 6, the massaging chair assembly 10 generally comprises a pad 12 is positionable on a seat in a vehicle wherein the pad 12 is configured to have a user sit thereon when the user sits in the vehicle. The pad 12 has a seat portion 14 forming an angle with a backrest portion 16 and a headrest portion 18 extending upwardly from the backrest portion 16. The pad 12 has a front surface 20 and a back surface 22, and the pad 12 is comprised of a resiliently compressible material to enhance comfort for the user.

A plurality of massage units 24 is provided and each of the massage units 24 is integrated into the pad 12 to abut the user when the user sits on the pad 12. Each of the massage units 24 orbits about a central point when the massage units 24 are turned on to massage the user. Each of the massage units 24 is positioned on the backrest portion 16 of the pad 12. Additionally, the massage units 24 are spaced apart from each other and are distributed between the seat portion 14 and the headrest portion 18. The massage units 24 are additionally centrally positioned on the backrest portion 16 thereby facilitating each of said massage units 24 to be aligned with the user's spine.

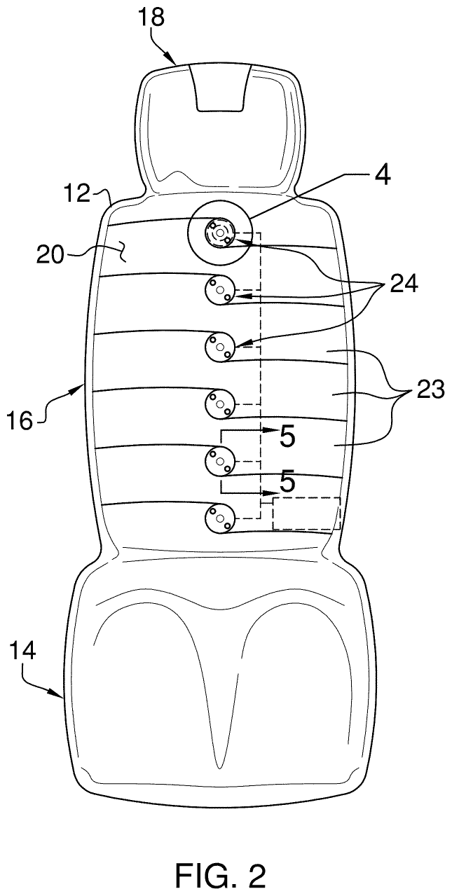

As is most clearly shown in FIGS. 1 and 2, the front surface 20 of the backrest portion 16 may comprise a plurality of cushions 23 that are vertically distributed between the seat portion 14 and the headrest portion 18. Each of the massage units 24 may be aligned with a threshold 25 between a respective pair of the cushions 23. Additionally, the threshold 25 between the respective pair of cushions 23 may alternately extend over and under each of the massage units 24.

Each of the massage units 24 comprises a housing 26 that has a front wall 28. The housing 26 is integrated into the pad 12 having the front wall 28 being oriented flush with the front surface 20 of the pad 12. A motor 30 is positioned within the housing 26 and the motor 30 rotates in a first direction when the motor 30 is turned on. The motor 30 is aligned with a center of the housing 26 and the motor 30 is actuatable to pulsate when the motor 30 is turned on. The motor 30 may comprise an electric motor or the like. Each of the massage units 24 includes a pair of balls 32 and each of the balls 32 is movably coupled to the front wall 28 of the housing 26. Each of the balls 32 is in mechanical communication with the motor 30 and each of the balls 32 orbits around the motor 30 when the motor 30 is turned on for massaging the user. Moreover, each of the balls 32 pulsates when the motor 30 is actuated to pulsate.

A heating element 34 is integrated into the pad 12 and the heating element 34 is in thermal communication with the pad 12 such that the heating element 34 heats the pad 12. In this way the heating element 34 warms the user when the user sits on the pad 12. The heating element 34 is positioned between the front surface 20 and the back surface 22 of the pad 12. The heating element 34 is formed into a plurality of loops 36 that are spaced apart from each other and are distributed throughout the pad 12. The heating element 34 may comprise an electric heating element that has a maximum operational temperature of approximately 150.0 degrees Fahrenheit.

A control unit 38 is integrated into the pad 12 and the control unit 38 is in electrical communication with each of the massage units 24 and the heating element 34. The control unit 38 comprises a control circuit 40 that is integrated into the pad 12 and the motor 30 of each of the massage units 24 is electrically coupled to the control circuit 40. Additionally, the heating element 34 is electrically coupled to the control circuit 40. The control circuit 40 receives a massage on input, massage off input, a heat on input and a heat off input. The motor 30 of each of the massage units 24 is turned on when the control circuit 40 receives the massage on input and the motor 30 of each of the massage units 24 is turned off when the control circuit 40 receives massage off input. Continuing, the heating element 34 is turned on when the control circuit 40 receives the heat on input and the heating element 34 is turned off when the control circuit 40 receives the heat off input.

The control unit 38 includes a receiver 42 that is integrated into the pad 12 and the receiver 42 is electrically coupled to the control circuit 40. The receiver 42 may comprise a radio frequency receiver or the like. A power supply 44 is coupled to the back surface 22 of the pad 12 and the power supply 44 is electrically coupled to the control circuit 40 and the receiver 42. The power supply 44 includes a charge port 45 that is recessed into the power supply 44.

The control unit 38 includes a charge cord 46 that has a first plug 48 and a second plug 50. The first plug 48 is pluggable into the charge port 45 for electrically coupling the charge cord 46 to the power supply 44. Additionally, the second plug 50 is pluggable into a power source 52 comprising a power port in the vehicle. Each of the first plug 48 and the second plug 50 may comprise a usb plug or the like. Additionally, the charge port in power supply 44 may comprise a usb port or the like. The power supply 44 may further include a rechargeable battery.

A cigarette lighter adapter 54 is included that can be inserted into a cigarette lighter, or other similar power port, in the vehicle. The cigarette lighter adapter 54 has a charge port 56 recessed therein. The charge port 56 in the cigarette lighter adapter 54 receives the second plug 50 when the second plug 50 is not plugged into the power source 52. In this way the cigarette lighter adapter 54 is configured to place the power supply 44 in electrical communication with the cigarette lighter in the vehicle. The charge port 56 in the cigarette lighter adapter 54 may comprise a usb port or the like.

A remote control 58 is carried by the user and the remote control 58 is in wireless communication with the control unit 38 for controlling operational parameters of the massage units 24 and the heating element 34. The remote control 58 comprises a remote control circuit 60 that is integrated into the remote control 58. The remote control 58 includes a transmitter 62 that is integrated into the remote control 58. The transmitter 62 is electrically coupled to the remote control circuit 60 and the transmitter 62 is in wireless communication with the receiver 42 in the control unit 38. The transmitter 62 broadcasts the massage on input, the massage off input, the heat on input and the heat off input to the control circuit 40 in the control unit 38 through the receiver 42. The transmitter 62 may comprise a radio frequency transmitter or the like.

A massage power button 64 is movably coupled to the remote control 58 and the massage power button 64 is electrically coupled to the remote control circuit 60. The transmitter 62 broadcasts the massage on input or the massage off input when the massage power button 64 is depressed. A heat power button 66 is movably coupled to the remote control 58 and the heat power button 66 is electrically coupled to the remote control circuit 60. The transmitter 62 broadcasts the heat on input or the heat off input when the heat power button 66 is depressed.

A temperature increase button 68 is movably coupled to the remote control 58 and the temperature increase button 68 is electrically coupled to the remote control circuit 60. The control circuit 40 in the control unit 38 increases the temperature of the heating element 34 toward a maximum temperature. A temperature decrease button 70 is movably coupled to the remote control 58 and the temperature decrease button 70 is electrically coupled to the remote control circuit 60. The control circuit 40 in the control unit 38 decreases the temperature of the heating element 34 toward a minimum temperature.

A rotate increase button 72 is movably coupled to the remote control 58 and the rotate increase button 72 is electrically coupled to the remote control circuit 60. The control circuit 40 in the control unit 38 increases the rotational speed of the motor 30 in the massage units 24 toward a maximum speed. A rotate decrease button 74 is movably coupled to the remote control 58 and the rotate decrease button 74 is electrically coupled to the remote control circuit 60. The control circuit 40 in the control unit 38 decreases the rotational speed of the motor 30 in the massage units 24 toward a minimum speed.

A pulse increase button 76 is movably coupled to the remote control 58 and the pulse increase button 76 is electrically coupled to the remote control circuit 60. The control circuit 40 in the control unit 38 increases the pulsation speed of the motor 30 in the massage units 24 toward a maximum pulsation. A pulse decrease button 78 is movably coupled to the remote control 58 and the pulse decrease button 78 is electrically coupled to the remote control circuit 60. The control circuit 40 in the control unit 38 decreases the rotational speed of the motor 30 in the massage units 24 toward a minimum speed. A remote power supply 80 is integrated into the remote control 58, the remote power supply 80 is electrically coupled to the remote control circuit 60 and the remote power supply 80 comprises at least one battery.

In use, the pad 12 is positioned on the seat in the vehicle and the sits on the pad 12. The remote control 58 is manipulated to turn on the massage units 24 or the heating element 34. In this way the user's back can be massaged and heat can be applied to the user's back while the user is driving. Thus, the user can reduce back pain that is commonly associated with sitting in a vehicle for extended periods of time. Additionally, the remote control 58 can be manipulated to adjust the temperature of the heating element 34, the rotational speed of the massage units 24 and the pulse intensity of the massage units 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massaging chair assembly for positioning on a vehicle seat for massaging a driver's back during driving, said assembly comprising:
a pad being positionable on a seat in a vehicle wherein said pad is configured to have a user sit thereon when the user sits in the vehicle;
a plurality of massage units, each of said massage units being integrated into said pad wherein each of said massage units is configured to abut the user when the user sits on said pad, each of said massage units orbiting about a central point when said massage units are turned on wherein each of said massage units is configured to massage the user;
a heating element being integrated into said pad, said heating element being in thermal communication with said pad such that said heating element heats said pad wherein said heating element is configured to warm the user when the user sits on said pad;
a control unit being integrated into said pad, said control unit being in electrical communication with each of said massage units and said heating element; and
a remote control being carried by the user, said remote control being in wireless communication with said control unit for controlling operational parameters of said massage units and said heating element.

2. The assembly according to claim 1, wherein:
said pad has a chair portion forming an angle with a backrest portion, said pad having a headrest portion extending upwardly from said backrest portion, said pad having a front surface and a back surface; and
each of said massage units is positioned on said backrest portion of said pad, said massage units being spaced apart from each other and being distributed between said seat portion and said headrest portion.

3. The assembly according to claim 1, wherein each of said massage units comprises a housing having a front wall, said housing being integrated into said pad having said front wall being oriented flush with a front surface of said pad.

4. The assembly according to claim 3, wherein each of said massage units includes a motor being positioned within said housing, said motor rotating in a first direction when said motor is turned on, said motor being aligned with a center of said housing, said motor being actuatable to pulsate when said motor is turned on.

5. The assembly according to claim 4, further comprising a pair of balls, each of said balls being movably coupled to said front wall of said housing, each of said balls being in mechanical communication with said motor, each of said balls orbiting around said motor when said motor is turned on wherein each of said balls is configured to massage the user, each of said balls pulsating when said motor is actuated to pulsate.

6. The assembly according to claim 2, wherein said heating element is positioned between said front surface and said back surface of said pad, said heating element being formed into a plurality of loops being spaced apart from each other and being distributed throughout said pad.

7. The assembly according to claim 4, wherein said control unit comprises a control circuit being integrated into said pad, said control circuit having said motor of each of said massage units being electrically coupled thereto, said control circuit having said heating element being electrically coupled thereto, said control circuit receiving a massage on input, massage off input, a heat on input and a heat off input.

8. The assembly according to claim 7, wherein said motor of each of said massage units is turned on when said control circuit receives said massage on input, said motor of each of said massage units being turned off when said control circuit receives massage off input.

9. The assembly according to claim 7, wherein said heating element is turned on when said control circuit receives said heat on input, said heating element being turned off when said control circuit receives said heat off input.

10. The assembly according to claim 7, wherein said control unit includes a receiver being integrated into said pad, said receiver being electrically coupled to said control circuit.

11. The assembly according to claim 10, wherein said control unit includes a power supply being coupled to said back surface of said pad, said power supply being electrically coupled to said control circuit and said receiver.

12. The assembly according to claim 11, wherein said power supply comprises:
a charge port being recessed into said power supply;
a charge cord having a first plug and a second plug, said first plug being pluggable into said charge port for electrically coupling said charge cord to said power supply, said second plug being pluggable into a power source comprising a power port in the vehicle; and
a cigarette lighter adapter being configured to be inserted into a cigarette lighter in the vehicle, said cigarette lighter adapter having a charge port being recessed therein, said charge port in said cigarette lighter adapter receiving said second plug when said second plug is not plugged into the power source wherein said cigarette light adapter is configured to place said power supply in electrical communication with the cigarette lighter in the vehicle.

13. The assembly according to claim 10, wherein said remote control comprises:
a remote control circuit being integrated into said remote control; and
a transmitter being integrated into said remote control, said transmitter being electrically coupled to said remote control circuit, said transmitter being in wireless communication with said receiver in said control unit, said transmitter broadcasting said massage on input, said massage off input, said heat on input and said heat off input to said control circuit in said control unit through said receiver.

14. The assembly according to claim 13, wherein said remote control comprises:
a massage power button being movably coupled to said remote control, said massage power button being electrically coupled to said remote control circuit, said transmitter broadcasting said massage on input or said massage off input when said massage power button is depressed;
a heat power button being movably coupled to said remote control, said heat power button being electrically coupled to said remote control circuit, said transmitter broadcasting said heat on input or said heat off input when said heat power button is depressed;
a temperature increase button being movably coupled to said remote control, said temperature increase button being electrically coupled to said remote control circuit, said control circuit in said control unit increasing the temperature of said heating element toward a maximum temperature; and
a temperature decrease button being movably coupled to said remote control, said temperature decrease button being electrically coupled to said remote control circuit, said control circuit in said control unit decreasing the temperature of said heating element toward a minimum temperature.

15. The assembly according to claim 13, wherein said remote control comprises:
a rotate increase button being movably coupled to said remote control, said rotate increase button being electrically coupled to said remote control circuit, said control circuit in said control unit increasing the rotational speed of said motor in said massage units toward a maximum speed;
a rotate decrease button being movably coupled to said remote control, said rotate decrease button being electrically coupled to said remote control circuit, said control circuit in said control unit decreasing the rotational speed of said motor in said massage units toward a minimum speed;
a pulse increase button being movably coupled to said remote control, said pulse increase button being electrically coupled to said remote control circuit, said control circuit in said control unit increasing the pulsation speed of said motor in said massage units toward a maximum pulsation; and
a pulse decrease button being movably coupled to said remote control, said pulse decrease button being electrically coupled to said remote control circuit, said control circuit in said control unit decreasing the rotational speed of said motor in said massage units toward a minimum speed.

16. A massaging chair assembly for positioning on a vehicle seat for massaging a driver's back during driving, said assembly comprising:
a pad being positionable on a seat in a vehicle wherein said pad is configured to have a user sit thereon when the user sits in the vehicle, said pad having a chair portion forming an angle with a backrest portion, said pad having a headrest portion extending upwardly from said backrest portion, said pad having a front surface and a back surface;
a plurality of massage units, each of said massage units being integrated into said pad wherein each of said massage units is configured to abut the user when the user sits on said pad, each of said massage units orbiting about a central point when said massage units are turned on wherein each of said massage units is configured to massage the user, each of said massage units being positioned on said backrest portion of said pad, said massage units being spaced apart from each other and being distributed between said seat portion and said headrest portion, each of said massage units comprising:
a housing having a front wall, said housing being integrated into said pad having said front wall being oriented flush with said front surface of said pad;
a motor being positioned within said housing, said motor rotating in a first direction when said motor is turned on, said motor being aligned with a center of said housing, said motor being actuatable to pulsate when said motor is turned on; and
a pair of balls, each of said balls being movably coupled to said front wall of said housing, each of said balls being in mechanical communication with said motor, each of said balls orbiting around said motor when said motor is turned on wherein each of said balls is configured to massage the user, each of said balls pulsating when said motor is actuated to pulsate;
a heating element being integrated into said pad, said heating element being in thermal communication with said pad such that said heating element heats said pad wherein said heating element is configured to warm the user when the user sits on said pad, said heating element being positioned between said front surface and said back surface of said pad, said heating element being formed into a plurality of loops being spaced apart from each other and being distributed throughout said pad;
a control unit being integrated into said pad, said control unit being in electrical communication with each of said massage units and said heating element, said control unit comprising:
a control circuit being integrated into said pad, said control circuit having said motor of each of said massage units being electrically coupled thereto, said control circuit having said heating element being electrically coupled thereto, said control circuit receiving a massage on input, massage off input, a heat on input and a heat off input, said motor of each of said massage units being turned on when said control circuit receives said massage on input, said motor of each of said massage units being turned off when said control circuit receives massage off input, said heating element being turned on when said control circuit receives said heat on input, said heating element being turned off when said control circuit receives said heat off input;
a receiver being integrated into said pad, said receiver being electrically coupled to said control circuit; and
a power supply being coupled to said back surface of said pad, said power supply being electrically coupled to said control circuit and said receiver, said power supply comprising:
a charge port being recessed into said power supply;
a charge cord having a first plug and a second plug, said first plug being pluggable into said charge port for electrically coupling said charge cord to said power supply, said second plug being pluggable into a power source comprising a power port in the vehicle; and
a cigarette lighter adapter being configured to be inserted into a cigarette lighter in the vehicle, said cigarette lighter adapter having a charge port being recessed therein, said charge port in said cigarette lighter adapter receiving said second plug when said second plug is not plugged into the power source wherein said cigarette light adapter is configured to place said power supply in electrical communication with the cigarette lighter in the vehicle; and
a remote control being carried by the user, said remote control being in wireless communication with said control unit for controlling operational parameters of said massage units and said heating element, said remote control comprising:
a remote control circuit being integrated into said remote control;
a transmitter being integrated into said remote control, said transmitter being electrically coupled to said remote control circuit, said transmitter being in wireless communication with said receiver in said control unit, said transmitter broadcasting said massage on input, said massage off input, said heat on input and said heat off input to said control circuit in said control unit through said receiver;
a massage power button being movably coupled to said remote control, said massage power button being electrically coupled to said remote control circuit, said transmitter broadcasting said massage on input or said massage off input when said massage power button is depressed;
a heat power button being movably coupled to said remote control, said heat power button being electrically coupled to said remote control circuit, said transmitter broadcasting said heat on input or said heat off input when said heat power button is depressed;
a temperature increase button being movably coupled to said remote control, said temperature increase button being electrically coupled to said remote control circuit, said control circuit in said control unit increasing the temperature of said heating element toward a maximum temperature;
a temperature decrease button being movably coupled to said remote control, said temperature decrease button being electrically coupled to said remote control circuit, said control circuit in said control unit decreasing the temperature of said heating element toward a minimum temperature;
a rotate increase button being movably coupled to said remote control, said rotate increase button being electrically coupled to said remote control circuit, said control circuit in said control unit increasing the rotational speed of said motor in said massage units toward a maximum speed;
a rotate decrease button being movably coupled to said remote control, said rotate decrease button being electrically coupled to said remote control circuit, said control circuit in said control unit decreasing the rotational speed of said motor in said massage units toward a minimum speed;
a pulse increase button being movably coupled to said remote control, said pulse increase button being electrically coupled to said remote control circuit, said control circuit in said control unit increasing the pulsation speed of said motor in said massage units toward a maximum pulsation;
a pulse decrease button being movably coupled to said remote control, said pulse decrease button being electrically coupled to said remote control circuit, said control circuit in said control unit decreasing the rotational speed of said motor in said massage units toward a minimum speed; and
a remote power supply being integrated into said remote control, said remote power supply being electrically coupled to said remote control circuit, said remote power supply comprising at least one battery.
